(19) United States
(12) Patent Application Publication
(10) Pub. No.: US 2011/0193994 A1
(43) Pub. Date: Aug. 11, 2011

(54) IMAGE PROCESSING DEVICE AND IMAGE PROCESSING METHOD

(76) Inventor: Tomoyuki NOZAWA, Fujisawa-shi (JP)

(21) Appl. No.: 13/018,766

(22) Filed: Feb. 1, 2011

(30) Foreign Application Priority Data
Feb. 8, 2010 (JP) 2010-025988
Aug. 31, 2010 (JP) 2010-193726

(51) Int. Cl. H04N 5/76

(52) U.S. Cl. 348/231.3; 348/E05.024

(57) ABSTRACT

An image processing device includes a storage medium in which a compound image file containing a plurality of image data items and a condition specifying a part of the image data items are stored, and an image data processing unit configured to perform image processing on the compound image file stored in the storage medium, specify an image data item satisfying the condition from the plurality of image data items, and store the specified image data item in the storage medium as a new image file.

### CROSS REFERENCE TO RELATED APPLICATION

The present application is based on and claims priority from Japanese Patent Application No. 2010-25988, flied on Feb. 8, 2010 and No. 2010-193726, filed on Aug. 31, 2010, the disclosure of which is hereby incorporated by reference in its entirety.

### BACKGROUND OF THE INVENTION

1. Field of the Invention

The present invention relates to an image processing device which combines a plurality of items of still image data into a single image file for storing. In particular, it relates to an image processing device and an image processing method which can easily delete an image file except for an image data item satisfying a specific condition and easily transmit only the image data item satisfying a specific condition to an external device.

2. Description of the Prior Art

Japanese Patent Application Publication No. 2008-167067 discloses a known image storing device in which a compound image file or a multi-image file containing a plurality of image data items are stored, for example. A known specification of the compound image file is defined as a multiple picture format (hereinafter, MPF) by the Camera and Imaging Products Association (“Multiple Picture Format”, CIPA DC-007-2009 defined on Feb. 4, 2009).

MPF is a specification for combining a plurality of image data items into a single image file for storing and realizes functions and performance which are not possible using a single image data item. An image file generated in compliance with the MPF (hereinafter, MP image file) contains individual image data items.

The MP image file includes header data containing information on the image data items. It is possible to know mutual relations among the image data items based on the header data and use the image data items as a single image file. This makes it easier for a user to store, reproduce, or manage an image file.

Meanwhile, the size of the MP image file is as large as about 12 MB to 27 MB since it contains a plurality of items of still image data. A large volume image file easily occupies a storage medium of the image storing device, preventing an effective use of the storage medium. The MP image file can be deleted when an available capacity of the medium becomes small. However, a problem arises when an MP image file to be deleted includes an image data item which a user wishes to save.

To avoid such a problem, it is necessary for a user to visually check reproduced image data items to find an image data item to save and store it as another image file before deleting the MP image file. When there are plural image data items to save in the MP image file, a user has to repeat the above visual check and storing before the deletion, which is very troublesome and inconvenient.

The same problem occurs when a user wishes to print or transfer a specific image data item from the MP image file. Image processing devices which can directly print or transfer an image file to an external device (printer or external memory device, for example) without a data processor such as a PC are now available.

Similarly to the deleting operation, a user needs to store a specific image data item in the MP image file as another image file before transmitting the MP image file to a printer. For transmitting (printing) a plurality of different image data items, a user has to repeat the above operation, which is also troublesome and inconvenient.

In addition, repeating the troublesome operation may cause a user to make operational errors such as erroneously deleting image data to save or erroneously transmitting unnecessary image data.

### SUMMARY OF THE INVENTION

The present invention aims to provide an image processing device and an image processing method which can save only an image data item satisfying a certain condition among a plurality of image data items contained in a compound image file as well as can easily delete or transmit the compound image file to an external device.

According to one aspect of the present invention, an image processing device comprises a storage medium in which a compound image file containing a plurality of image data items and a condition specifying a part of the image data items are stored; and an image data processing unit configured to perform image processing on the compound image file stored in the storage medium, specify an image data item satisfying the condition from the plurality of image data items, and store the specified image data item in the storage medium as a new image file.

### BRIEF DESCRIPTION OF THE DRAWINGS

Features, embodiments, and advantages of the present invention will become apparent from the following detailed description with reference to the accompanying drawings:

FIG. 1 is a front view of an example of an image processing device according to one embodiment of the present invention;

FIG. 2 is a top view of the image processing device;

FIG. 3 is a back view of the image processing device;

FIG. 4 is a function block of the image processing device by way of example;

FIG. 5 shows an example of a structure of an MP image file stored in the image processing device;

FIG. 6 shows an example of a partial data structure of the MP image file;

FIG. 7 shows an example of a structure of data contained in the data structure in FIG. 6;

FIG. 8 shows the data structure in FIG. 7 in detail;

FIG. 9 shows an example of format of a storage medium used in the image processing device;

FIG. 10 is an exemplary flowchart for file deleting process of an image processing method according to one embodiment of the present invention;

FIGS. 11A to 11C show an example of a screen display on which the file deleting operation is executed;

FIG. 12 is an exemplary flowchart for the file deleting process;

FIGS. 13A, 13B show an example of a screen display on which a file transmission is executed

FIG. 14 is an exemplary flowchart for the file transmission;

FIG. 15 is an exemplary flowchart for another example of the image processing method; and

FIG. 16 is an exemplary flowchart for still another example of the image processing method.

### PREFERRED EMBODIMENTS OF THE PRESENT INVENTION

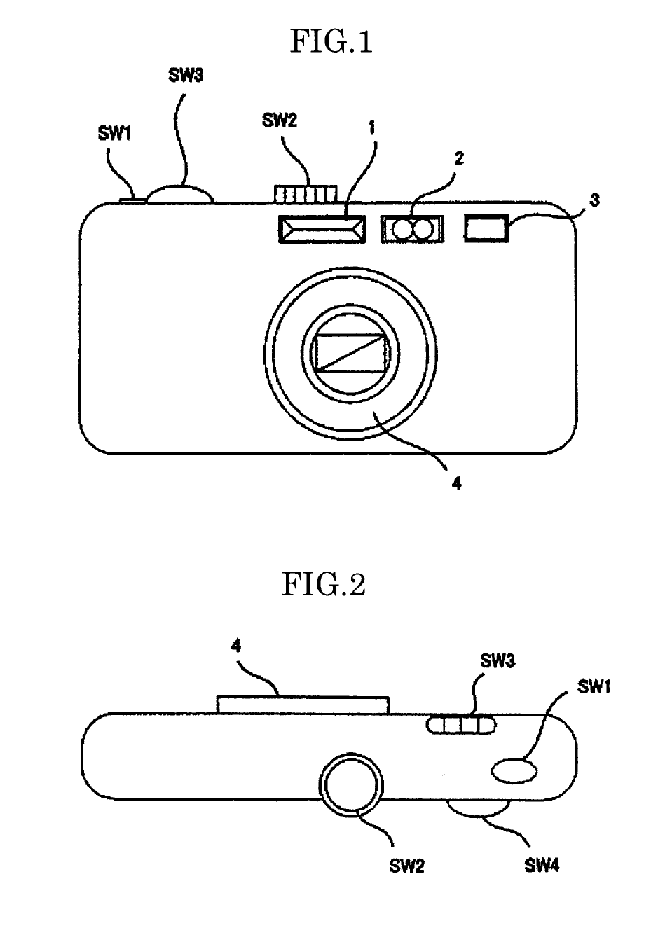

Hereinafter, embodiments of image processing device and method according to the present invention will be described in detail with reference to the accompanying drawings. FIGS. 1 to 3 show front, top, back views of a digital camera as an example of an image processing device according to one embodiment of the present invention respectively.

### First Embodiment

In FIG. 1 the digital camera comprises, on the front face, a strobe light unit 1, a ranging portion 2 measuring a distance to a subject, an optical viewfinder 3, a lens barrel unit 4 including a zoom lens and a focus lens.

As shown in FIG. 2, the digital camera comprises, on the top face, a release button SW1, a mode dial SW2, and jog dial switches SW3, SW4. The upper side of the drawing is the front face and the lower side is the back face.

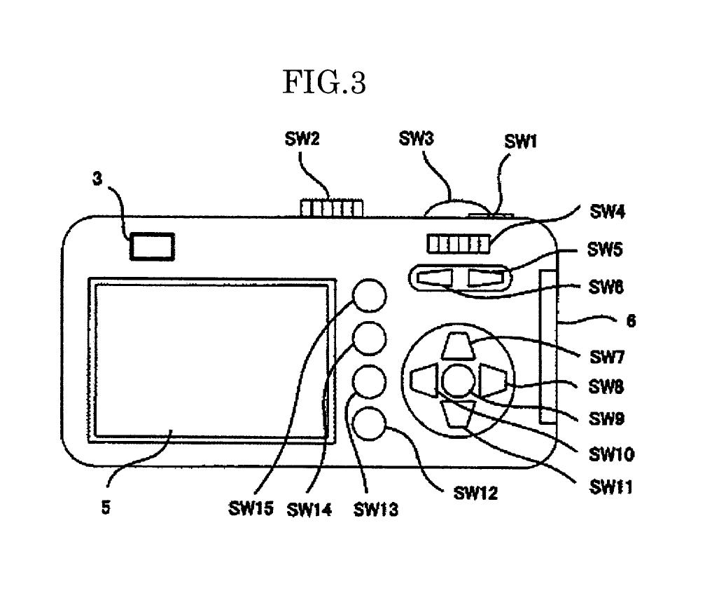

In FIG. 3, the digital camera comprises, on the back face, the optical viewfinder 3, an LCD 5, a telescopic zoom switch SW5, a wide-angle zoom switch SW6, an upward switch SW7, a rightward switch SW8, an OK switch SW9, a leftward switch SW10, a downward switch SW11, a display switch SW12, a delete switch SW 13, a menu switch SW14, and a power switch SW15. On a side face a battery lid 6 for battery container is provided.

Although not shown, the digital camera includes, on one side, a connection interface communicably connecting with an external device. It can transmit image files to the external device via the connection interface.

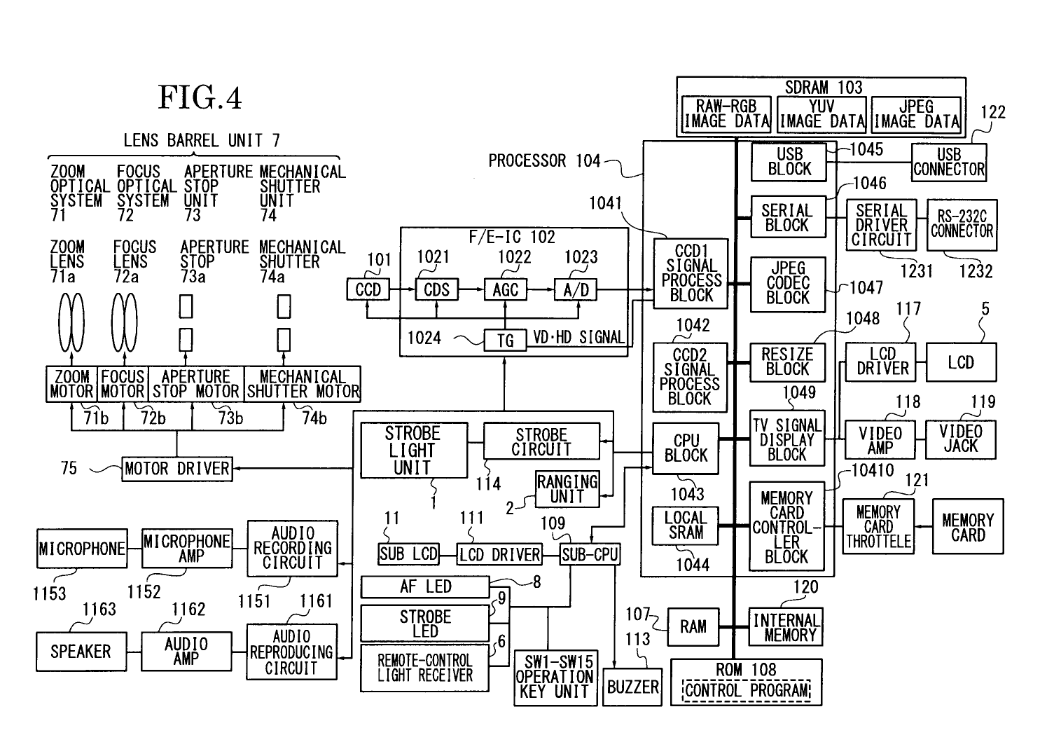

FIG. 4 shows an example of the function blocks of the digital camera according to the present embodiment. The operations (functions) of the digital camera are controlled by a processor 104 as a digital signal processing integrated circuit (IC).

The processor 104 comprises a first charge coupled device (CCD1) signal processing block 1041, a second CCD (CCD2) signal processing block 1042, a CPU block 1043, a local SRAM (static random access memory) 1044, a USB (universal serial bus) block 1045, a serial block 1046, a JPEG CODEC block 1047, a resize block 1048, a TV signal display block 1049 and a memory card controller block 10410. These blocks are connected with each other by bus lines.

Light from a subject incident via the lens system of the lens barrel unit 7 forms an image on the light-receiving face of the CCD 101 and is converted into an electric image signal. An F/E-IC 102 performs predetermined processing to the image signal from the CCD 101 and outputs it to the CCD1 signal processing block 1041. The F/F-IC 102 includes a correlated double sampling (CDS) 1021 obtaining a difference in signal level according to incident light, an automatic gain controller (AGC) 1022 correcting the magnitude of an input signal and an analog-digital (A/D) converter 1023.

The F/F-IC 102 processes the image signals in synchronization with vertical drive (VD)/horizontal drive (HD) signals output from the CCD1 signal processing block 1041. A timing generator (TG) 1024 controls the synchronization of the signals.

The lens barrel unit 7 comprises a zoom optical system 71 having a zoom lens 71a, a focus optical system 72 having a focus lens 72a, an aperture stop unit 73 having an aperture stop 73a and a mechanical shutter unit 74 having a mechanical shutter 74a. The optical zoom system 71, optical focus system 72, aperture stop unit 73 and mechanical shutter unit 74 are driven by a zoom motor 71b, a focus motor 72b, an aperture stop motor 73b and a mechanical shutter motor 74b, respectively. These motors are driven by a motor driver 75 which is controlled by a drive signal of the processor 104.

The processor 104 obtains RAW-RGB data output from the F/E-IC 102 via the CCD1 signal processing block 1041 and stores it in the SDRAM 103. Also, later-described YUV data and JPEG data are stored in the SDRAM 103. The RAW-RGB data is converted into YUV data in the CCD2 signal processing block 1042 and YUV data is compressed to JPEG data in the JPEG CODEC block 1047. YUV data is for color representation of image data based on brightness data (Y), a difference (U) between color difference (brightness data) and blue (B) color data, and a difference (V) between brightness data and red (R) color data.

An operation key unit (SW1 to SW15) comprises the release button SW1, mode dial SW2, telescopic zoom switch SW5, wide-angle zoom switch SW6, OK switch SW9, delete switch SW 13, menu switch SW14 and else. By a user's manipulation to the respective switches, drive signals are input to the processor 104 via a sub-CPU 109 for predetermined processing.

The CPU block 1043 controls a stroboscopic circuit 114 to emit light from the strobe light unit 1 and also controls the ranging unit 2. It also controls an LCD driver 111 to control a display on the sub LCD 1. The sub CPU 109 is connected with the autofocus LED 8, the strobe LED 9, the remote-control light receiver 6, and a buzzer 113.

The USB block 1045 is connected to a USB connector 122 to which a not-shown USB cable is connected. Via the USB cable, the digital camera is communicably connected to an external device such a printer or a hard disk as an external memory device. The digital camera is configured to be able to transfer image files from a later-described memory card (storage medium) to the external device. The serial block 1046 is connected to a RS-232C connector 1232 through a serial driver circuit 1231. The TV signal display block 1049 is connected to the LCD 5 via the LCD driver 117 and to a video jack 119 via a video amplifier 118.

The memory card controller block 10410 is connected to a contact point between a memory card throttle 121. With a memory card inserted into the throttle 121, compound image files and image files can be recorded on the memory card. The LCD driver 117 drives the LCD 5 and converts video signals from the TV signal display block 1049 to signals for display on the LCD 5. The LCD 5 displays a subject before shooting, a captured image, and image data stored in the memory card or an internal memory 120.

Upon a user's manipulation to the mode dial SW2 to set a shooting mode and press to the power switch SW15, the digital camera is activated in the shooting mode. When detecting the activation, a control signal is output to the motor driver 75 to move the lens barrel unit 7 to a shooting position according to a control program stored in an ROM 108. Further, according to the control program, the CCD 101, F/E-IC 102, the processor 104 and else are activated.

By directing the lens barrel unit 7 at the subject, an optical image of the subject is formed on the light receiving face of the CCD 101, and an electric signal (analog RGB image signal) from the CCD 101 is converted into RAW-RGB data in 12 bits via the F/E-IC 102. The RAW-RGB data is sent to the CCD1 signal processing block 1041 and stored in the SDRAM 103.

The RAW-RGB data is read from the SDRAM 103, converted into YUV data in the CCD2 signal processing block 1042, and stored in the SDRAM 103. Displayable YUV data are read from the SDRAM 103 and transmitted to the LCD 5. Thereby, a captured image is displayed. In a viewfinder mode a captured image is displayed on the LCD 5. In the viewfinder mode the CCD1 signal processing block 1041 thins out the number of pixels to read one frame of YUV data in every 1/30 second. The LCD 5 functions as an electric finder to continuously display a captured image until a user manipulates the release button SW1.

A user can check a captured image on the LCD 5 or on an external TV connected to the video jack 119 via a cable.

The first CCD signal processing block 1041 calculates an AF (autofocus) evaluation value, an AE (auto exposure) evaluation value, and an AWB (auto white balance) evaluation value from the RAW-RGB data output from the F/E-IC 102.

The AF evaluation value is calculated by integrating output values of a high frequency component filter or integrating differences in brightness of neighboring pixels, for example. When a subject is in focus, the edge portion of a subject image is sharp and clear, which includes highest frequency components. Accordingly, a subject is in in-focus state when a value obtained by the above integration is highest. Specifically, in the AF operation (focus detection), the AF evaluation value is calculated at different positions while the focus lens 72a is moved. A lens position with the maximum AF evaluation value is determined to be an in-focus position and the focus lens 72a is moved to the in-focus position.

The AE and AWB evaluation values are calculated from respective integration values of RGB values of the RAW-RGB data. For example, a screenful of image corresponding to all the pixels of the CCD 101 is equally divided into 256 areas (horizontally 16, vertically 16) to calculate RGB values in each area. Based on the control program in the ROM 08, a calculated RGB integration value is read to calculate brightness in each area and determine a proper exposure amount from brightness distribution (AE operation). Also, under the control program, an exposure condition (number of electric shutters of the CCD 101, aperture value of the aperture stop unit 73, and else) is set based on the determined exposure amount.

Further, in the AWB operation a control value is determined in accordance with color of light from a subject from RGB distributions. Through the AWB operation, white balance of an image is adjusted when the CCD2 signal processing block 1042 performs the YUV data conversion. In the viewfinder mode the AE and AWB operations are continuously executed by the control program.

Upon a press to the release button SW1 in the viewfinder mode, a still image shooting operation starts and the AF operation and still image recording are performed. That is, the motor driver 75 is instructed to drive by the control program and move the focus lens 72a to the in-focus position. Then, in the AE operation the motor driver 75 is instructed to close the mechanical shutter at a start of exposure. An analog RGB image signal is output from the CCD 101 and converted into RAW-RGB data by the A/D converter 1023 of the F/E-IC102.

The converted RGB-RAW data are input to the CCD1 signal processing block 1041, converted into YUV data in the CCD2 signal processing block 1042 and stored in the SDRAM 103. The YUV data is then read from the SDRAM 103, converted into a size compatible with the number of recorded pixels in the resize block 1048, and compressed to image data in JPEG format in the JPEG codec block 1047. The compressed image data are written in the SDRAM 103 and stored in a storage medium such as a memory card 1211 via the memory card controller block 10410.

The image processing device according to the present embodiment comprises operation modes selectable by manipulation to the mode dial SW2. The operation modes includes a plurality of MP shooting modes in which an MP image file is stored. In the MP shooting modes, a plurality of imaging operations are performed at a single shooting. As a result, plural image data items are stored as a single MP image file.

Next, an example of operation in the MP shooting mode is described. The image processing device is configured to start the AF operation, upon detecting a half press to the release button SW1 and determine plural in-focus positions in the AF operation. Then, it moves the lens system to the determined in-focus positions and performs imaging processing, upon detecting a full press to the release button SW1. Thus, it is made possible to perform plural imaging operations at a single shooting, acquire plural image data items and store them as a single MP image file. This MP shooting mode is referred to as a special AF mode. In the special AF mode, for example, seven image data items are continuously acquired in a single shooting operation.

An example of another MP shooting mode is described. This MP shooting mode is referred to as a first continuous shooting mode. While the release button SW1 is being pressed, shooting operation is intermittently performed with a predetermined interval. At a timing when the release button SW1 is returned to the original position (when a user releases the release button SW1), last 15 or 30 image data items among all of captured image data items are stored as a single MP image data 100.

An example of still another MP shooting mode is described. This MP shooting mode is referred to as a second continuous shooting mode. In the second continuous shooting mode shooting operation is continuously performed 120 times in about every second (120 frames per second) or about every two seconds (60 frames per second) at a timing when the release button SW1 is fully pressed. Image data items continuously acquired are stored as a single MP image file. The digital camera according to the present embodiment comprises the above special AF mode and first and second continuous shooting modes.

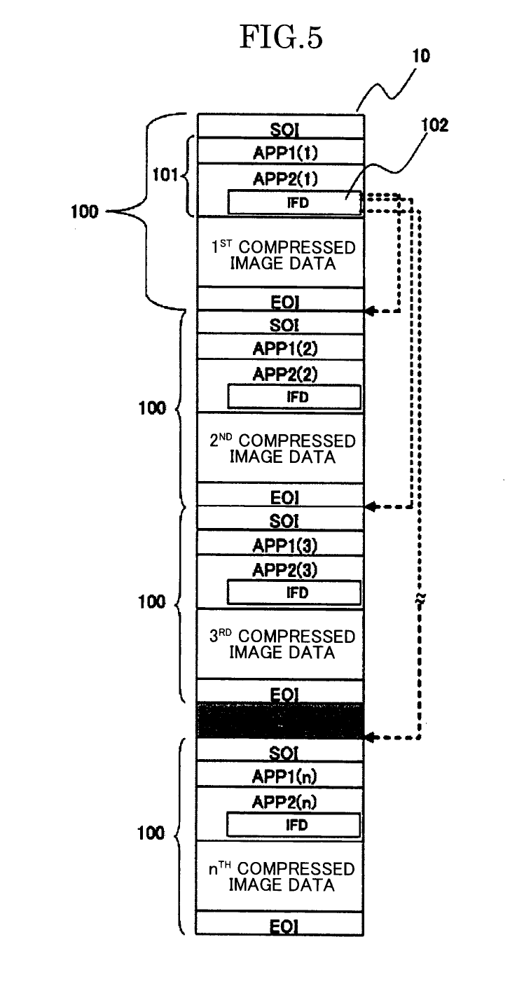

Next, an MP image file stored in a storage medium (mounted in the memory card throttle 121 or SDRAM 103) of the digital camera is described with reference to FIG. 5.

FIG. 5 shows a data structure of an MP image file by way of example. An MP image file 10 in the drawing contains plural image data items 100. A header 101 thereof contains header data APP1 including various data on the MP image file 10 and header data APP2 defined by the MP specification. The image data item 100 includes marker codes SOI and EOI indicating a head and an end of data and the header 101 and image data compressed in a predetermined format between the SOI and EOI.

Each item of image data has data structure in Exif format which is a general image file format used for digital cameras. The header data APP1 contains Exif auxiliary data while the header data APP2 subsequent to the header data APP1 contains MPF format auxiliary data. Each item of image data 100 is compressed in a JPEG format defined by Exif.

Further, the header 101 contains relevant data on the image data items 100. The relevant data refers to, for example, the amount of the image data items 100 contained in the MP image file 10, and SOI position data and size of each image data item 100.

An MP index IFD 102 is contained in the header data APP2 of a first image data item 100, and it indicates information on representative image data. Herein, representative image data refers to image data representing all the image data items contained in the MPF image file 10.

In FIG. 5 broken lines from the MP index IFD of the first image data item 100 to the other image data items 100 indicate that data in the MP index IFD indicates head positions (SOI) of the respective image data items.

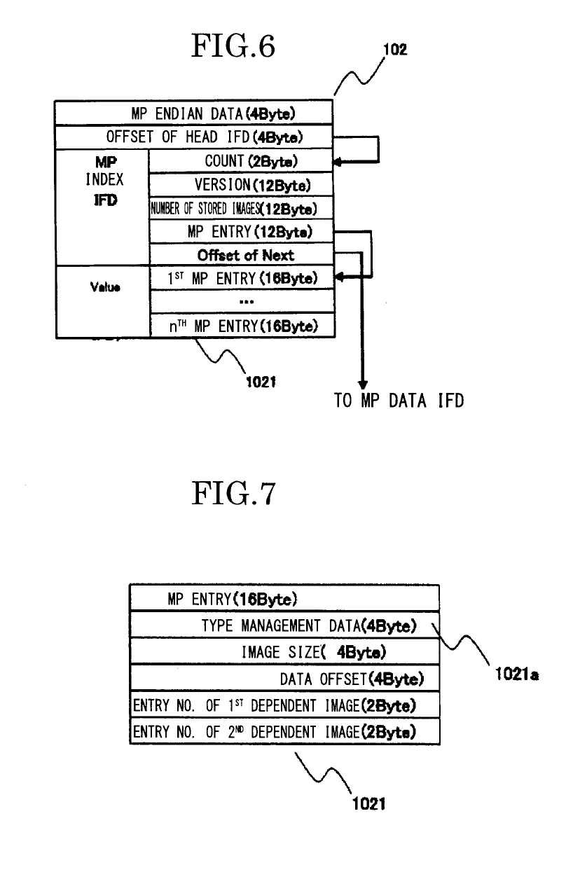

Next, an example of data structure of the MP index IFD is described with reference to FIG. 6. The MP index IFD 102 includes data indicating a version of MP relevant data, the amount of the image data items 100 contained in the MP image file 10, an MP entry 1021 as a data group including type management data indicating a type of image data items 100, and a data size and data offset thereof.

Referring to FIG. 7, the data structure of the MP entry 1021 is described. A data group contained in the MP entry 1021 includes type management data 1021a, a data size of an image data item 100 from the SOI to EOI, and an offset value of the SOI. The number of the MP entries 1021 in the MP index IFD coincides with the amount of the image data items 100 in the MP image file 10.

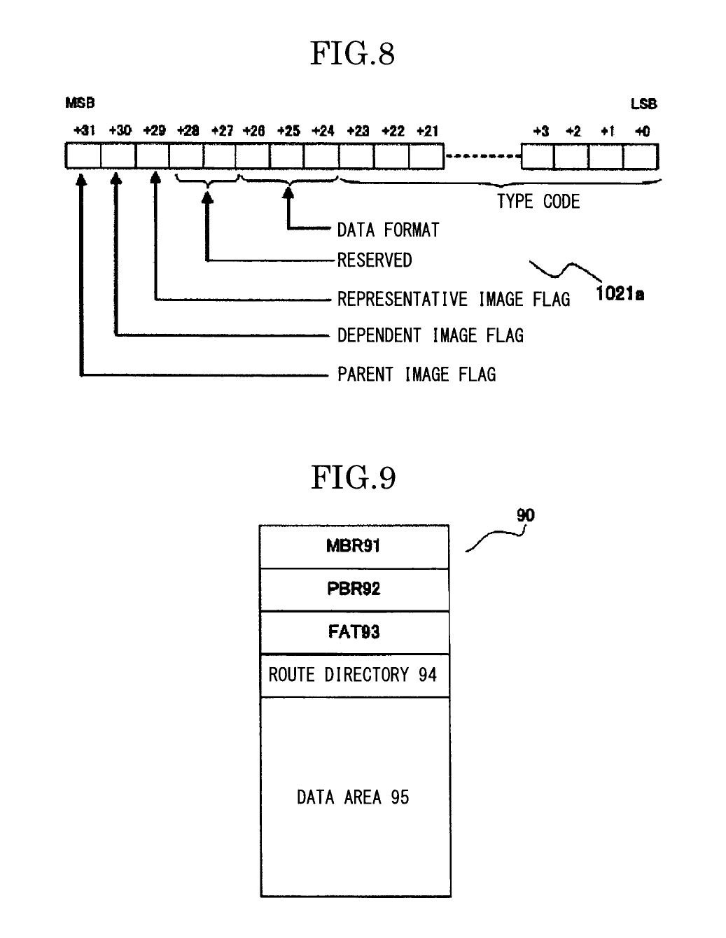

Next, an example of structure of the type management data 1021a in the MP entry 1021 is described with reference to FIG. 8. The type management data 1021a is of a 4-byte length, and a parent image flag, a dependent image flag, and a representative image flag are allocated to each bit from the uppermost bit MSB in order.

The 28^{th} and 27^{th} bits are reserved bits, data formats are allocated to the 26^{th} to 24^{th} bits, and type codes are allocated to the 23^{rd} bit to LSB.

The parent image flag indicates that there is any/no dependent image data item (one dependent on another image data item) on an image data item 100 in question. When there is one, the flag is set to 1, and when there is no dependent image data item, the flag is set to zero.

The dependent image flag indicates that an image data item 100 in question is or is not dependent on another image data item 100. When the image data 100 is a dependent image data item, the flag is set to 1, and when it is not, the flag is set to zero.

The representative image flag indicates that an image data item 100 is or is not representative image data. When the image data item 100 is representative image data, the flag is set to 1, and when it is not, the flag is set to zero. The representative image data will be later described.

Data on data format of an image data item 100 is stored in 3 bits from the 26^{th} to 24^{th} bits (data format). For example, if data format of an image data item 100 is JPEG, “000” is stored.

Type code indicating a type of an image data item 100 is stored on the 23^{rd} bit to LSB (code). Types of image data items 100 are a main image, a live view image, a panorama image, a stereoscopic image, a multi-angle image and else, for example.

Now, a process in which the representative image flag is set to 1 (representative image is designated) is described. Using the digital camera according to the present embodiment, for instance, after predetermined shooting operation a user can read an MP image file from the storage medium and designate an image data item 100 as a representative image data with the OK switch SW9 while visually checking image data items 100 on the display.

The image processing device in the present invention can be configured to execute the representative image data designation automatically after the shooting operation. For example, for an MP image file 10 captured in the special AF mode, AF evaluation values of the image data items 100 in the MP image file 10 are compared to determine an image data item 100 with a highest AF evaluation value to be representative image data. Then, the representative image flag of this image data item 100 is set to 1. Based on the AF evaluation value, an image data item 100 captured in best focus is selected from continuously captured image data items 100 as representative image data of the MP image file 100.

Alternatively, an image data item 100 captured at the nearest or farthest lens position or captured at intermediate focal point can be designated as representative image data. Then, the representative image flag of such an image data item 100 is set to 1.

Moreover, for the MP image file 10 captured in the first continuous shooting mode, any of image data items 100 captured first, middle, and last can be designated as representative image data from image data items 10 shot when the release button SW1 is released. Alternatively, an image data item 100 with a highest AF evaluation value can be designated as representative image data, as in the special AF mode. Then, the representative image flag of such an image data item 100 is set to 1.

Similarly, for the MP image file 10 captured in the second shooting continuous mode, any of image data items 100 captured first, middle, and last can be designated as representative image data from a predetermined number of image data items 10 shot after the release button SW1 is fully pressed. Alternatively, an image data item 100 with a highest AF evaluation value can be designated as representative image data, as in the special AF mode. Then, the representative image flag of such an image data item 100 is set to 1. Note that conditions for designating the representative image data are preset in the image processing device.

The MP image file 10 is read/written in a predetermined data format from/to the storage medium included in the image processing device. FIG. 9 shows an example of a data format used in a storage medium applicable to the image processing device according to the present embodiment. In a storage medium 90, data regions for MBR 91, PBR 92, FAT 93, route directory 94, and data area 95 are formed in order from the top in the drawing.

MBR 91 stores a partition table containing positions and sizes of partitions formed in the storage medium 90. PBR 92 stores data assigned to a head sector of the partition and defining data storage format used in the storage medium 90.

FAT 93 is plural sectors following PBR 92 and stores table data for managing use/nonuse status of the data area 95 and a linkage of files stored in the data area 95 in unit of cluster. Generally, data such as image files stored in the storage medium 90 is managed in unit of cluster. It is therefore necessary to read data in a single image file stored in plural clusters from one cluster to another in order. Data stored in the FAT 93 indicates a linkage of clusters and is called a FAT chain.

The route directory 94 stores entries of image files and sub directories (additional directories). The entries refer to, for example, file names of data stored, file attributes, reserved regions, date and time of file generation or update, physical positions (FAT start number) of image files or sub directories, file size and else.

Data stored in the MBR 91, PBR92, FAT 93, and route directory 94 are important file management data for storing an image file in the storage medium 90. The data area 95 following the route directory stores contents (data) of files (for example, image file) and sub directory data.

Next, deletion of an image file from the data area 95 is described. According to the present embodiment, in the image deletion process a part or all of file management data associated with an image file to be deleted is deleted. After the process, the deleted image file cannot be browsed or edited as if it was ultimately deleted. However, actually the image file is not ultimately deleted from the data area 95 but remains stored therein until overwritten with another file.

### Second Embodiment

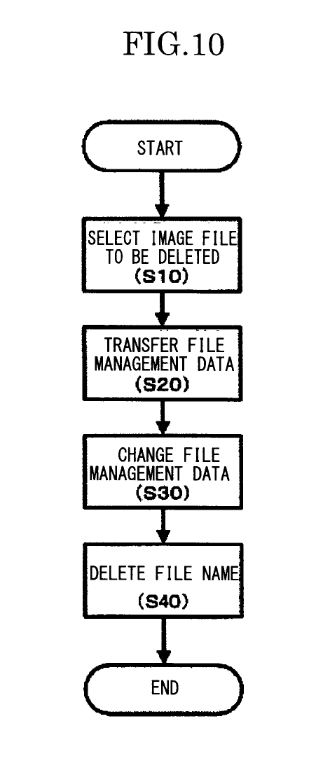

Now, an example of an image processing method executed by the image processing device according to the present embodiment is described with reference to FIG. 10. FIG. 10 shows an example of deletion process for an image file stored in the storage medium.

In step S10 a user manipulates the deletion switch SW13 to start a deletion mode and visually check image files on the LCD 5 to decide one to be deleted with the OK switch SW9. Then, the deletion process for the image file is started. In step S20 data in the FAT 9 for managing the data area 95 containing the selected image file is copied and transferred to an internal memory such as the SDRAM 103.

In step S30 the usage status of the data area 95 in question stored in the FAT 93 is changed from “in use” to “non-use” after the saving process. The data area 95 becomes available for a next image file stored. Changing the usage status refers to, for example, changing a value of the data area in the FAT 93 to “00” in hexadecimal. After changing the value in the FAT 93, a file name of the directory entry is deleted in step S40. The deletion of the file name is not actual deletion of the data but changing the top letter thereof to a code “E5” in hexadecimal to indicate the deletion thereof, for example.

Thus, the image file deletion from the storage medium 90 is not to eliminate all the data on the image file but to place the file management data for the image file in a deleted state. Therefore, for restoring a deleted image file, the file management data is restored to the one before the deletion process.

### Third Embodiment

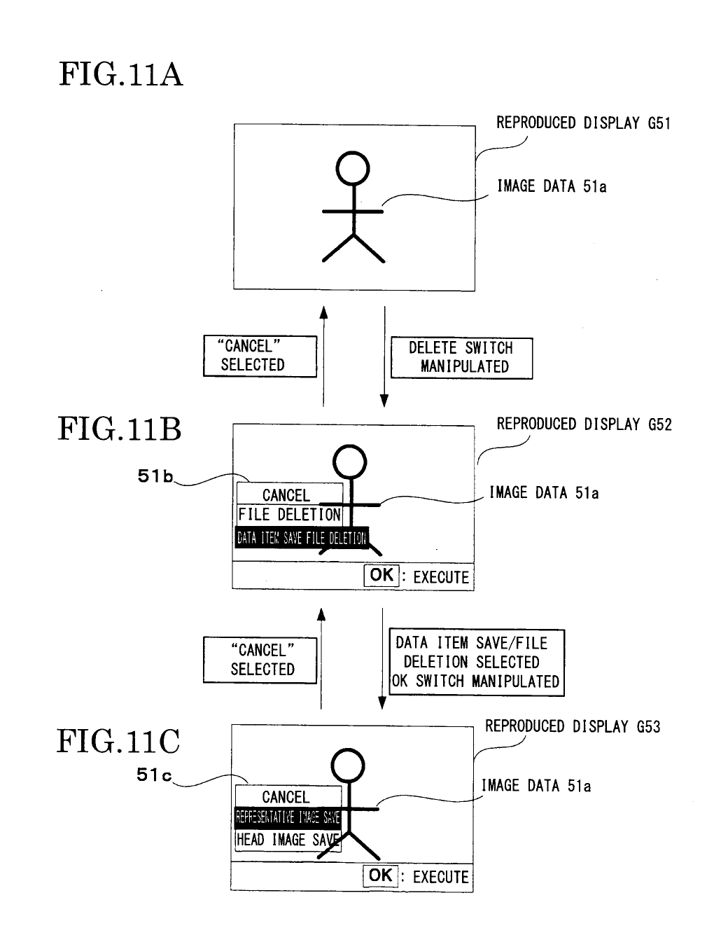

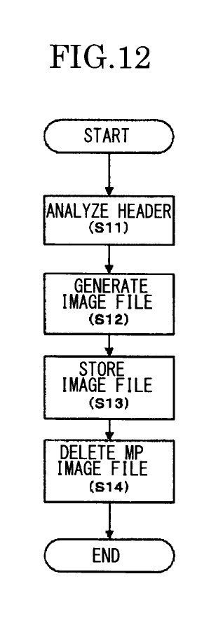

Next, another example of the image processing method executed by the image processing device, i.e., deletion of an MP image file, is described with reference to FIGS. 11A to 11C and 12. FIGS. 11A to 11C show an example of an image display and an operation menu on the LCD 5 in the deletion process. As shown in FIG. 11A, a reproduced display G51 is displayed on the LCD 5 when a user manipulates the mode dial SW2 to set a reproduction mode. The reproduced display G51 is an example of the MP image file 10 read from the storage medium. A user can visually check the content of the MP image file 10, image data 51a as an example of image data item on the display.

A user manipulates the rightward and leftward switches SW8, SW10 during the reproduced display G51, to sequentially read other MP image files 10 from the storage medium for display and delete a desired image file by a predetermined manipulation such as pressing the deletion switch SW 13. This determines the MP image file 10 to be deleted.

Upon the deletion switch SW13 being pressed, a reproduced display G52 is displayed on the LCD 5 as shown in FIG. 11B. The reproduced display G52 is an example of a display of a delete menu 51b on the image data 51a. The delete menu 51b includes items such as “cancel” to cancel the operation, “file deletion” to collectively delete all the image data items 100 contained in an MP image file 10 displayed and the MP image file, and “data item save” to delete the MP image file 10 except for an image data item 100 satisfying a specific condition.

Then, a user selects an item from the delete menu 51b by moving a cursor with the upward and downward switches SW7, SW11 to point the item on the menu 51b and press the OK switch SW9, for example.

When the item “cancel” is selected from the delete menu 51b, the delete menu 51b is cleared from the display and the display is returned to the reproduced display G51. When the item, “file deletion” is selected, the MP image file 10 in question is deleted. Specifically, the status of a certain data area of the FAT 93 for the MP image file is changed to “non-use”.

When the item “data item save/file deletion” is selected, a reproduced display G53 as shown in FIG. 11C is displayed on the LCD 5. The reproduced display G53 is an example of displaying a delete menu 51c on the image data 51a. The delete menu 51a includes items such as “cancel” to cancel the operation, “representative image save” to store in the storage medium representative image data of the image data items in a displayed MP image file 10 as a new image file and delete the MP image file 10, and “head image save” to store image data stored at the head of the displayed MP image file 10 as a new image file and delete the MP image file 10. By operating the upward switch SW7 and downward switch SW11, an intended deletion process is selected on the reproduced display G53.

When the item “cancel” is selected from the delete menu 51c, the menu 51c is cleared from the display, and the reproduced display G52 showing the delete menu 51b is returned on the LCD5. When the item “representative image save” is selected, an image data item with a representative image flag being 1 is specified from the image data items 100 in the MP image file 10 and stored as a new image file in the storage medium, and the MP image file 10 is deleted. Specifically, EXIF header data is added to the specified image data item to generate a new image file and store it in the storage medium according to the present embodiment.

When the item “head image save” is selected from the delete menu 51c, an image data item stored at the head of the MP image file 10 is specified and stored as a new image file in the storage medium, and the MP image file 10 is deleted.

Thus, according to the image processing executed in the image processing device according to the present embodiment, it is made possible to easily delete an MP image file at less number of manipulations after storing an image data item satisfying a specific condition as a new image file.

Next, “representative image save” process is described with reference to FIG. 12. In step S11 the header 101 of the MP image file selected (displayed on the LCD 5) is analyzed. Specifically, the content of the APP2 of a head image data item 100 is analyzed to determine an image data item 100 with a representative image flag being 1 and acquire an offset address of the image data item 100.

Then, in step S12 the determined image data item 100 is generated as a new image file. The new image file can be automatically given a file name based on a certain condition by using a part of the file name of the original MP image file 10 for example. Suppose that the file name of the original MP image file 10 is “RIMG0014.JPG”, for instance, the new image file is to be given a name “RIMG0014_{—}001.JPG” which clearly shows the association with the original MP image file 10. Alternatively, the name of the new image file can be one indicating the position of the image data item 100 in question in the MP image file 10.

In step S13, the generated image file is stored in the storage medium. Thereafter, the MP image file 10 is deleted in step S14. That is, the file management data of the MP image file 10 is changed to one indicating “non-use” as described above. Thus, the image processing device according to the present embodiment can delete the MP image file 10 after storing as a new image file an image data item 100 satisfying a specific condition (representative image flag being 1 in the present embodiment).

As described above, the image processing device is configured to automatically delete an MP image file containing a plurality of image data items after storing an image data item 100 satisfying a specific condition as a new image file in the storage medium. This accordingly allows a user to save a desired image data item among the image data items in the MP image file by a simple operation and then easily delete the MP image file automatically.

In the present embodiment a condition for deciding an image file to store is selected from the delete menu 51c. However, the present invention should not be limited thereto. Alternatively, a setup menu used for initial setting can be configured to include items related to the MP image file deletion and set a condition for specifying an image data item for example.

In a case where such a specifying condition is preset in the image processing device, upon selection of the item “file deletion” on the reproduced display G52 in FIG. 11B, image data satisfying the condition can be stored as an image file in the storage medium without changing to the display to the reproduced display G53 and the MP image file is deleted. Alternatively, after the selection, the reproduced display G52 can be changed to the reproduced display G53 to select the preset specifying condition thereon.

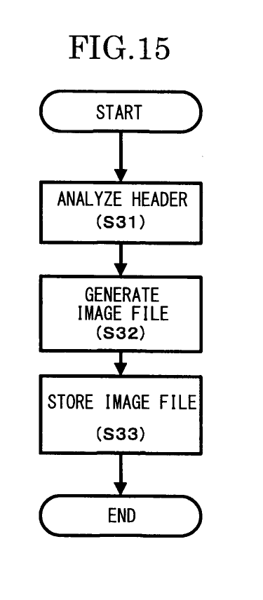

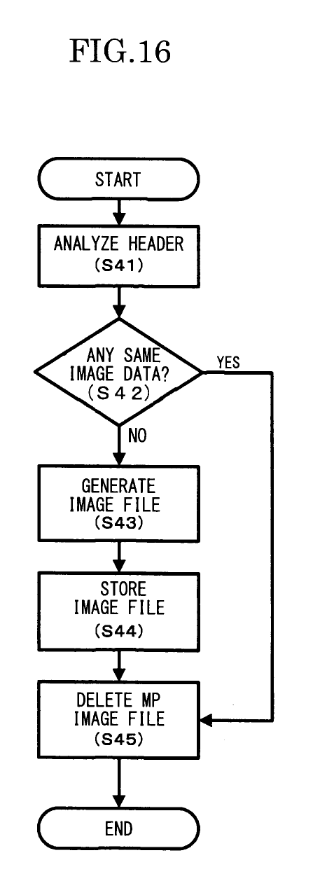

The present embodiment has described an example where an image data item (representative or head image data) satisfying a specific condition is stored as a new image file in the storage medium in the MP image file deletion process. The image processing according to the present invention should not be limited to such an example. Another example of separately performing data storing and file deletion will be described with reference to FIGS. 15, 16.

FIG. 15 is a flowchart for selecting a desired image data item 100 from the image data items 100 contained in the MP image file 10 and automatically storing as a new image file only. In step S31 the header 101 of the MP image file 10 displayed on the LCD 5 is analyzed by a predetermined operation such as analyzing the content of the APP2 of the head image data item 100 in the MP image file 10 to specify an image data item 100 with a representative image flag being 1 or specifying the head image data. A condition to specify the image data item can be set in advance. In step S32 the specified image data item is generated as a new image file and stored in the storage medium in step S33.

FIG. 16 is a flowchart for deleting an MP image file discontinuously from the image data storing. In step S41 the header 101 of the MP image file 10 displayed on the LCD 5 is analyzed. In step S42 a determination is made on whether or not an image file containing the same image data as that specified in step S41 is stored in the storage medium, for example. Specifically, it can be determined whether or not a file name corresponding to that of a new image file generated from the MP image file is stored. Alternatively, it can be determined using a brightness distribution in pixels of the image data item satisfying the condition by comparing the image file specified in the step 41 and the one stored in the storage medium to determine how much they match with each other. It is determined that the same image file is stored in the storage medium when the file matches with the specified image file at a higher degree than a predetermined value.

When it is determined that the same image file is already stored (Yes in S42), the MP image file is deleted in step S45 without storing the image data item as a new file. When it is determined that the same image file is not stored (No in S42), the specified image data item is generated as a new image file in step S43 and stored in the storage medium in step S44 and then the MP image file is deleted in step 45.

Thus, in the image processing according to the present embodiment, for separately performing the new image file storing and the MP image file deletion, it is possible for a user to store a desired image data item and automatically delete the MP image file without unnecessarily storing an image file.

### Fourth Embodiment

Next, an image processing device according to a fourth embodiment is described. The image processing device can be communicably communicated with an external device (not shown) to transmit image files stored in the storage medium to the external device, as described above.

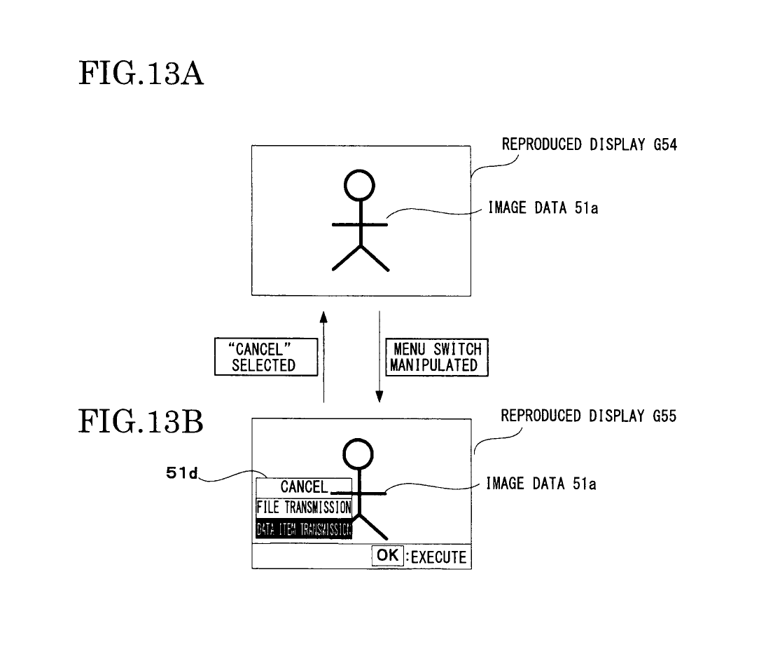

An image transmission process to the external device in the image processing executed by the image processing device is described with reference to FIGS. 13A, 13B. FIGS. 13A, 13B show an example of a display change in the image transmission process.

Upon a user's manipulation to the mode dial SW2 to set the reproduction mode, a reproduced display G54 appears on the LCD 5 as shown in FIG. 13A. The reproduced display G54 is an example of display of the MP image file 10, specifically, an image data item contained at the head of the MP image file. The user can visually check the content of the MP image file 10, image data 51a on the display as shown in FIG. 13A.

Other MP image files 10 are read from the storage medium and displayed sequentially by repetitive manipulation to the rightward and leftward switches SW8, SW10 during the reproduced display G54. When an MP image file 10 containing a desired image is displayed, transmission of the MP image file 10 is decided by a predetermined operation such as pressing the menu switch SW 14.

When an item “transmission” is selected from a not-shown operation menu by manipulation to the menu switch SW14, a transmission menu 51d is displayed on the image data 51a on a reproduced display G55. The transmission menu 51d includes items such as “cancel” to cancel operation, “file transmission” to transmit all the image data items 100 in the displayed MP image file to the external device, and “data item transmission” to transmit only an image data item 100 satisfying a specific condition to the external device.

Then, the user selects a desired process from the transmission menu 51d by moving a cursor with the upward and downward switches SW7, SW11, pointing an intended item, and pressing the OK switch SW9, for example.

Upon the item “cancel” selected from the transmission menu 51d, the transmission menu 51d is cleared and the display is returned to the reproduced display G54. Upon “file transmission” selected, the MP image file 10 in question is transmitted to the external device.

Upon the item “data item transmission” selected, an image data item 100 satisfying a specific condition is selected from the displayed MP image file 10, temporarily stored as a new image file in the storage medium, and transmitted to the external device. The image file transmitted to the external device can be an image file in which EXIF header data is added to the image data item 100 or solely an image data item 100 not in file.

Thus, according to the image processing executed by the image processing device according to the present embodiment, it is possible to select only image data satisfying a specific condition from the MP image file and transmit it to the external device such as a printer. It is therefore possible to easily print specific image data only.

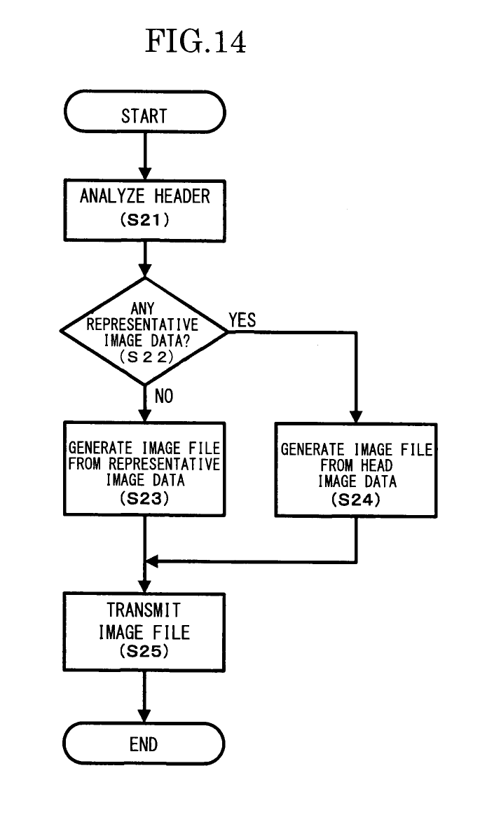

Next, the image transmission process is described with reference to FIG. 14. First, in step S21 the header 101 of a selected MP image file 10 is analyzed. Specifically, the content of the APP2 of an image data item 100 at the head of the MP image file 10 is analyzed.

In step S22 a determination is made on whether or not there is any image data item 100 with a representative image flag being 1 in the MP image file 10.

With the image data item 100 with the representative image flag being 1 found (Yes in step S22), the offset address of this item 100 is acquired from the APP2 of the MP image file 10. An image file is generated from the image data item 100 designated by the offset address in step S23.

The generated image file can be automatically provided a file name under a certain condition. For example, the file name can be created using a part of the original MP image file 10. Suppose that the file name of the original MP image file 10 is “RIMG0014.JPG”, for instance, the new image file is to be given a name “RIMG0014_{—}001.JPG” which clearly shows the association with the original MP image file 10. Alternatively, the name of the new image file can be one indicating the position of the image data item 100 in question stored in the MP image file 10.

With no image data item 100 with the representative image flag being 1 found (No in step S22), the offset address of a head image data item 100 in the MP image file 10 is acquired from the APP2, and a file size of an image data item 100 designated by the offset address is acquired to read the head image data item 100 and generate a new image file in step S24.

The generated image file is stored in the SDRAM 103 or the memory card, and read therefrom and transmitted to the external device in step S25. With the external device being a printer, the image file is printed thereby while with the external device being storage medium, the image file is stored therein.

The image processing device according to the present embodiment can transmit an image data item satisfying a specific condition (representative image flag being 1 in the present embodiment) as an image file to the external device. This makes it possible to easily print or store only certain image data in the MP image file.

The image processing device can be configured to display a warning on the LCD5 in the data transmission process instead of the transmission of the head image data when there is no representative image data. Alternatively, it can be configured to specify and display the image data item satisfying a specific condition and transmit it after checking transmission/non-transmission of the item 100.

Thus, the image processing device according to any of the above embodiments can automatically specify an image data item satisfying a specific condition from an MP image file containing multiple image files without visually checking individual image data and store the specified image data as a new image file. Therefore, it is able to easily and quickly delete an MP image file and transmit only a new image file to the external device without failure.

The deletion process executed by the image processing device according to the above embodiments is applicable to image processing of a data processor such as a personal computer. The image processing device can automatically store only an intended image file and easily transmit an image data item satisfying a specific condition to the external device without troublesome operation.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. An image processing device comprising:
a storage medium in which a compound image file containing a plurality of image data items and a condition specifying a part of the image data items are stored; and
an image data processing unit configured to perform image processing on the compound image file stored in the storage medium, specify an image data item satisfying the condition from the plurality of image data items, and store the specified image data item in the storage medium as a new image file.

2. An image processing device according to claim 1, wherein
the image data processing unit is configured to delete the compound image file after storing the specified image data item in the storage medium as a new image file.

3. An image processing device according to claim 1, wherein
the image data processing unit is configured to determine whether or not the specified image data item is stored in the storage medium as a new image file;
when determining that the specified image data item is stored in the storage medium as a new image file, the image data processing unit deletes the compound image file from the storage medium; and
when determining that the specified image data item is not stored in the storage medium as a new image file, the image processing unit deletes the compound image file after storing the specified image data item in the storage medium as a new image file.

4. An image processing device according to claim 1, wherein
when the image processing device is connected with an external device, the image data processing unit is configured to transmit the new image file from the storage medium to the external device.

5. An image processing device according to claim 1, wherein
when the image processing device is connected with an external device, the image data processing unit is configured to delete the compound image file from the storage medium after transmitting the new image file from the storage medium to the external device.

6. An image processing device according to claim 1, wherein
the specified image data item is representative image data in the compound image file.

7. An image processing device according to claim 6, wherein
the representative image data is an image data item with a largest AF evaluation value among the plurality of image data items contained in the compound image file.

8. An image processing device according to claim 1, wherein
the specified image data item is an image data item stored in a head position in the compound image file.

9. An image processing device according to claim 1, further comprising:
an imaging unit configured to convert an optical image of a subject into an electric signal to generate image data; and
a compound image file generator configured to generate a compound image file containing a plurality of generated image data items, wherein
the compound image file generated by the compound image file generator is stored in the storage medium.

10. An image processing method executed by an image processing device, comprising the steps of:
storing, in a storage medium, a compound image file containing a plurality of image data items and a condition specifying a part of the plurality of image data items contained in the compound image file; and
perform image processing on the compound image file stored in the storage medium, specifying an image data item satisfying the condition from the plurality of image data items and storing the specified image data item in the storage medium as a new image file.

11. An image processing method according to claim 10, further comprising the step of
deleting the compound image file after storing the specified image data item in the storage medium as a new image file.

12. An image processing method according to claim 10, further comprising the steps of:
determining whether or not the specified image data item is stored in the storage medium as a new image file;
when determining that the specified image data item is stored in the storage medium as a new image file, deleting the compound image file from the storage medium; and
when determining that the specified image data item is not stored in the storage medium as a new image file, deleting the compound image file after storing the specified image data item in the storage medium as a new image file.

13. An image processing method according to claim 10, further comprising the step of
when the image processing device is connected with an external device, transmitting the new image file from the storage medium to the external device.

14. An image processing method according to claim 10, further comprising the step of
when the image processing device is connected with an external device, deleting the compound image file from the storage medium after transmitting the new image file from the storage medium to the external device.

15. An image processing method according to claim 10, wherein
the specified image data item is representative image data in the compound image file.

16. An image processing method according to claim 15, wherein
the representative image data is an image data item with a largest AF evaluation value among the plurality of image data items contained in the compound image file.

17. An image processing method according to claim 10, wherein
the specified image data item is an image data item stored in a head position in the compound image file.

18. An image processing method according to claim 10, further comprising the steps of:
converting an optical image of a subject into an electric signal to generate image data;
generating a compound image file containing a plurality of generated image data items; and
storing the generated compound image file in the storage medium.
